(19) United States
(12) Patent Application Publication
(10) Pub. No.: US 2024/0305318 A1
(43) Pub. Date: Sep. 12, 2024

(54) DUAL-CONNECTIVITY MOBILE SATELLITE COMMUNICATION

(71) Applicant: Apple Inc., Cupertino, CA (US)

(72) Inventors: Wassim El-Hassan, San Jose, CA (US); Brian H. Bremer, Arlington Heights, IL (US); Lydi Smaini, San Jose, CA (US); Abhinav Dayal, San Jose, CA (US); Daphne I. Gorman, San Jose, CA (US); Xuefeng Zhao, San Jose, CA (US)

(21) Appl. No.: 18/432,987

(22) Filed: Feb. 5, 2024

Related U.S. Application Data
(60) Provisional application No. 63/450,807, filed on Mar. 8, 2023.

(51) Int. Cl. H04B 1/00

(52) U.S. Cl. CPC H04B 1/0064; H04B 1/0075

(57) ABSTRACT

A wireless communication includes multiple transceivers that may be utilized for wireless communication over multiple frequency ranges. One of the transceivers is communicatively coupled to antennas that may be utilized to transmit or receive wireless signals having frequencies in different portions of one of the frequency ranges.

### CROSS-REFERENCE TO RELATED APPLICATIONS

This application claims priority to U.S. Application No. 63/450,807, entitled “DUAL-CONNECTIVITY MOBILE SATELLITE COMMUNICATION,” filed Mar. 8, 2023, which is hereby incorporated by reference in its entirety for all purposes.

### BACKGROUND

The present disclosure relates generally to wireless communication, and more specifically to the transmission and reception of wireless signals over multiple frequency ranges.

In an electronic device, a transmitter and a receiver may each be coupled to one or more antennas to enable the electronic device to both transmit and receive wireless signals over one or more frequency ranges. For example, the electronic device may transmit or receive wireless signals over various frequency ranges depending on a type of wireless communication being utilized, such as, WI-FI® communication, BLUETOOTH® communication, or communication utilizing a cellular network (e.g., a 3^{rd} generation (3G) cellular network, universal mobile telecommunication system (UMTS), 4^{th} generation (4G) cellular network, Long Term Evolution® (LTE) cellular network. Long Term Evolution License Assisted Access (LTE-LAA) cellular network, a 5th generation (5G) cellular network, a 6th generation (6G) cellular network, a beyond-6G cellular network, and so on). As other forms of wireless communication become available or utilized, it may be desirable to enable electronic devices to communicate utilizing such forms of wireless communication while also being able to communicate using other forms of wireless communication (e.g., WI-FI® communication, BLUETOOTH® communication, or communication utilizing a cellular network).

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a wireless communication system includes a first transceiver that is configured to transmit and receive one or more first wireless signals over a cellular network using a first frequency range. The wireless communication system also includes at least one antenna communicatively coupled to the first transceiver to transmit and receive the one or more first wireless signals. Also, the wireless communication system includes a second transceiver that is configured to transmit and receive one or more second wireless signals over a non-terrestrial network using a second frequency range. Additionally, the wireless communication system includes a plurality of antennas communicatively coupled to the second transceiver. The plurality of antennas includes one or more first antennas to transmit and receive a first portion of the one or more second wireless signals in a first portion of the second frequency range. The plurality of antennas also includes one or more second antennas to transmit and receive a second portion of the one or more second wireless signals in a second portion of the second frequency range.

In another embodiment, a method includes transmitting or receiving, via a first transceiver and at least one antenna communicatively coupled to the first transceiver, one or more first wireless signals over one or more cellular networks using a first frequency range. The method also includes transmitting or receiving, via a second transceiver and one or more first antennas of a plurality of antennas communicatively coupled to the second transceiver, a first portion of one or more second wireless signals over one or more non-terrestrial networks using a first portion of a second frequency range. Additionally, the method includes transmitting or receiving, via the second transceiver and one or more second antennas of the plurality of antennas, a second portion of the one or more second wireless signals over the one or more cellular networks or the one or more non-terrestrial networks using a second portion of the second frequency range.

In yet another embodiment, an electronic device includes a first transceiver configured to transmit and receive one or more first wireless signals over a cellular network using a first frequency range. The electronic device also includes a second transceiver configured to transmit and receive one or more second wireless signals over a non-terrestrial network using a second frequency range. Additionally, the electronic device includes a plurality of antennas communicatively coupled to the second transceiver. The plurality of antennas includes one or more first antennas configured to receive a first portion of the one or more second wireless signals. The plurality of antennas also includes one or more second antennas configured to transmit a second portion of the one or more second wireless signals.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a block diagram of a wireless communication system that may be included in the electronic device of FIG. 1, according to embodiments of the present disclosure;

FIG. 6 is a block diagram of a transceiver subsystem that may be included in the wireless communication system of FIG. 5, according to embodiments of the present disclosure;

FIG. 7 is a block diagram of a yet another transceiver subsystem that may be included in the wireless communication system of FIG. 5, according to embodiments of the present disclosure; and

FIG. 8 is a flowchart of a process that the electronic device of FIG. 1 may perform to transmit and/or receive radio frequency signals on multiple frequency ranges, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to enabling wireless communication using different types of wireless communication that may utilize several frequency ranges (e.g., of wireless signals that are transmitted and/or received). For example, an electronic device may transmit or receive wireless signals over various frequency ranges depending on a type of wireless communication being utilized, such as, WI-FI® communication, BLUETOOTH® communication, or communication utilizing a cellular network (e.g., a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, a 5th generation (5G) cellular network, a 6th generation (6G) cellular network, a beyond-6G cellular network, and so on). As other forms of wireless communication become available or utilized, it may be desirable to enable electronic devices to communicate utilizing such forms of wireless communication while also being able to communicate using other forms of wireless communication (e.g., WI-FI® communication, BLUETOOTH® communication, or communication utilizing a cellular network).

Embodiments described herein provide various apparatuses and techniques to enable electronic devices to wirelessly communicate over several frequency ranges (e.g., in multiple wireless networks). To do so, the embodiments described herein include a wireless communication system that may include transceivers utilized for wireless communication over particular frequency ranges or wireless networks. Indeed, as described below, a wireless communication system may include transceivers and antennas that may be utilized for transmitting and receiving millimeter wave (mmWave) RF signals over mobile communication networks and RF signals over non-terrestrial networks.

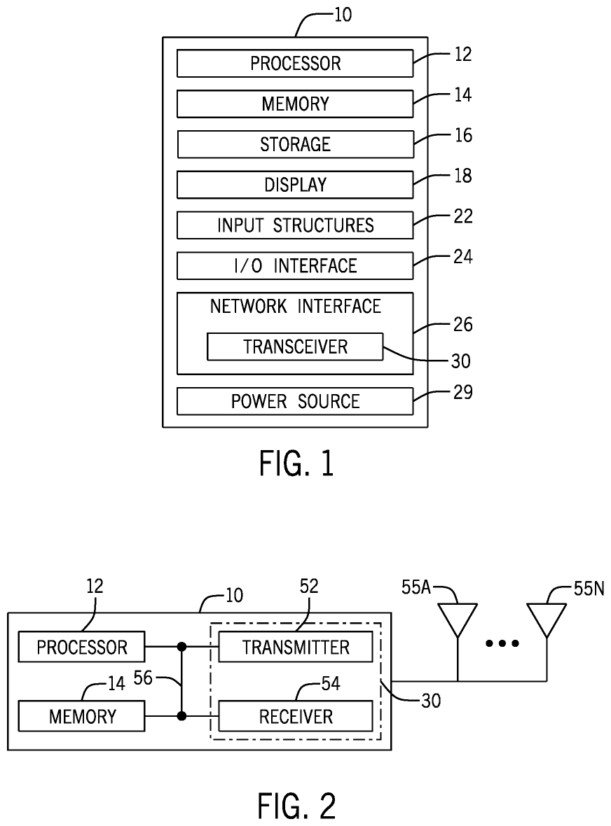

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the Institute of Electrical and Electronics Engineers (IEEE) 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter. The electronic device 10, through the network interface 26 or the transceiver 30, may enable wireless communicate over several frequency ranges (e.g., using multiple wireless networks). To do so, the electronic device 10 may include a wireless communication system having multiple transceivers 30 utilized for wireless communication over particular frequency ranges or wireless networks. Indeed, as described below, the wireless communication system may include transceivers 30 and antennas that may be utilized for transmitting and receiving millimeter wave (mmWave) RF signals over mobile communication networks and RF signals over non-terrestrial networks, in accordance with the embodiments described herein.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

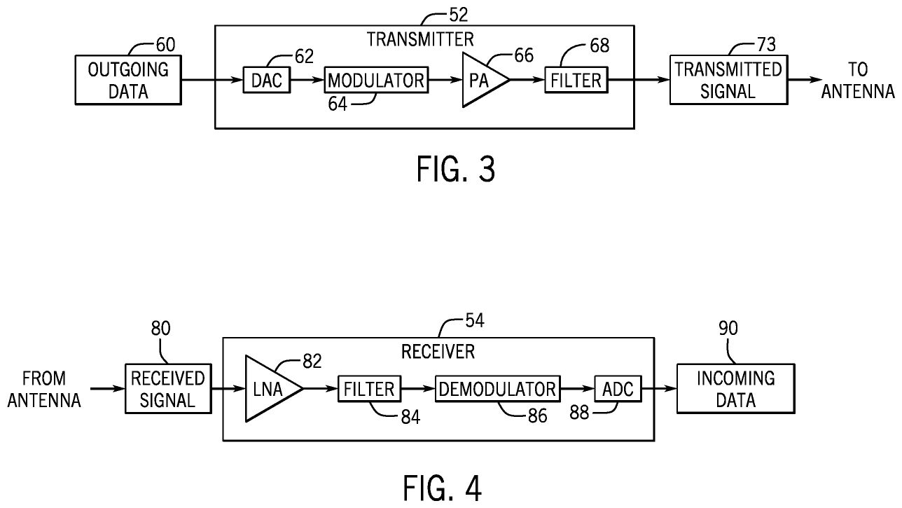

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 73 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10.

A demodulator 86 may remove a radio frequency carrier signal and/or extract a demodulated signal (e.g., an envelope signal) from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter.

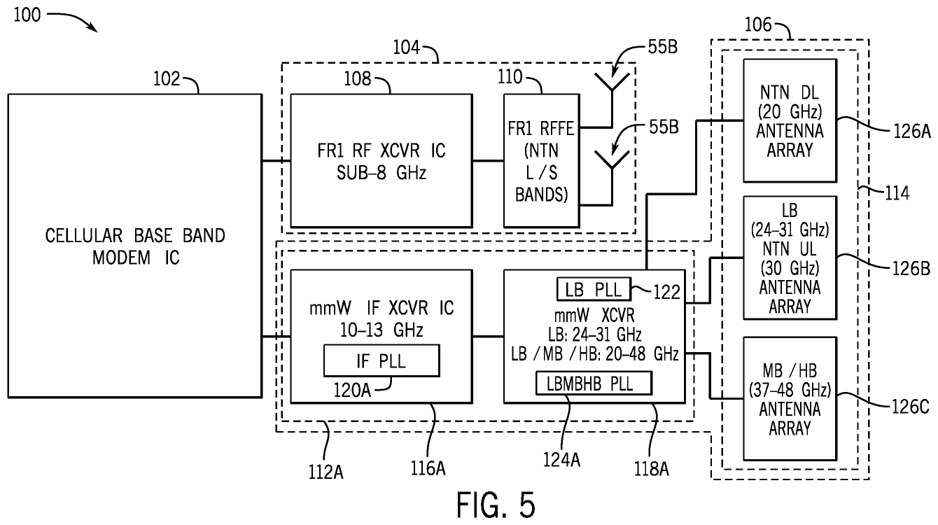

As noted above, the present disclosure describes techniques that may be utilized to communicate wirelessly using several different frequency ranges (e.g., frequency bands) that may be associated with different forms of wireless communication. In particular, as described below, an electronic device (e.g., electronic device 10) may include wireless communication circuitry that enables the electronic device to transmit and receive wireless signals in a PAN (e.g., a BLUETOOTH® network), a LAN or WLAN (e.g., a network employing one of the IEEE 802.11x family of protocols, such as WI-FI®), a cellular network (e.g., 5G cellular network, a 6G cellular network, a beyond-6G cellular network, and so on) and/or a WAN, which may be a satellite network or a non-terrestrial network. Bearing this in mind, FIG. 5 is a block diagram of a wireless communication system 100 that may be included in the electronic device 10 (e.g., fully or partially included in the network interface 26) and enable the electronic device 10 to communicate over several wireless networks, including but not limited to, PANs, WLANs, cellular networks, and non-terrestrial networks. As illustrated, the wireless communication system 100 includes a baseband integrated circuit (IC) 102, a first wireless communication subsystem 104, and a second wireless communication subsystem 106. The first wireless communication subsystem 104 may be utilized for wireless communication utilizing particular frequency ranges (e.g., bands), such as frequencies that are at or below 6 GHz or at or below 8 GHz. The second wireless communication subsystem 106 may be utilized for wireless communication using other frequencies ranges or bands. Indeed, in one embodiment, the first wireless communication subsystem 104 may be utilized for sub-6 GHz mobile network wireless communication (e.g., on a 5G cellular network, a 6G cellular network, or beyond-6G cellular network), while the second wireless communication subsystem 106 may be utilized for other frequencies (e.g., frequencies greater than 6 GHZ, such as frequencies of 10 GHz or greater). In particular, the second wireless communication subsystem 106 may be utilized for mmWave mobile network communication (e.g., on a 5G cellular network, a 6G cellular network, or beyond-6G cellular network) and for non-terrestrial network communication. Accordingly, the first wireless communication subsystem 104 may communicate on one or more frequency bands in Frequency Range 1 (e.g., sub-6 GHz frequency bands, from 410 MHZ to 7125 MHz) as defined by the 3GPP, and the second wireless communication subsystem 106 may communicate in Frequency Range 2 (e.g., 24.25 GHZ to 71.0 GHZ) as defined by the 3GPP.

The baseband IC 102 may include an integrated circuit (e.g., processor, system-on-chip (SOC), etc.) that may generate baseband signals from which radio frequency (RF) signals may be generated by the first wireless communication subsystem 104 and the second wireless communication subsystem 106. Additionally, the baseband IC 102 may receive signals (e.g., signals received via an antenna 55 of the electronic device 10 or signals generated therefrom) from the first wireless communication subsystem 104 and the second wireless communication subsystem 106. The baseband IC 102, the first wireless communication subsystem 104, and/or the second wireless communication subsystem 106 may be included in and/or communicatively coupled to the processor 12. As such, the processor 12 may control the baseband IC 102 as well as the first wireless communication subsystem 104 and the second wireless communication subsystem 106 (e.g., to cause the wireless communication system 100 to generate wireless signals to be transmitted). Additionally, the processor 12 may process signals received from the first wireless communication subsystem 104, the second wireless communication subsystem 106, and the baseband IC 102.

The first wireless communication subsystem 104 may include a transceiver 108, a radio frequency front end (RFFE) 110, and antennas 55B that are utilized for wireless communication in a frequency range, such as frequencies of or less than 6 GHZ that may be utilized for sub-6 GHZ mobile network wireless communication (e.g., using RF signals in the IEEE L band (e.g., frequencies from 1 GHZ to 2 GHZ) and/or the IEEE S band (e.g., frequencies from 2 GHZ to 4 GHZ)). The transceiver 108 may be implemented on or as an integrated circuit. As such, the transceiver 108 may be implemented on or as part of the processor 12. The transceiver 108 and the RFFE 110 may be representative of the transceiver 30 and/or be implemented as the transceiver 30. Accordingly, the transceiver 108 and the RFFE 110 may include the transmitter 52 (and components thereof) and the receiver 54 (and components thereof), which may function as described above. For instance, when transmitting, the transceiver 108 may receive baseband signals (which may be or include the outgoing data 60) from the baseband IC 102 and, with the RFFE 110, generate and send the transmitted signal 70 to the antennas 55B. For example, the RFFE 110 may include the power amplifier 66 and/or the filter 68 that may respectively amplify and/or filter signals received from the transceiver 108. Conversely, when receiving, the RFFE 110 may receive signals (e.g., the received signal 80) from the antennas and, with the transceiver 108, generate the incoming data 90.

The antennas 55B may be included in the antennas 55A-55N and be configured to transmit, receive, or transmit and receive wireless signals. While two antennas 55B are illustrated in FIG. 5, in other embodiments, the first wireless communication subsystem 104 may include one antenna 55B, three antennas 55B, or more than three antennas 55B.

The second wireless communication subsystem 106, as illustrated, includes a transceiver subsystem 112A and an antenna subsystem 114. The second wireless communication subsystem 106 may be utilized for wireless communication in another frequency range, such as frequencies of or greater than 10 GHz that may be utilized for, for example, mmWave mobile network wireless communication and non-terrestrial network communication. Accordingly, by utilizing the first wireless communication subsystem 104 and the second wireless communication subsystem 106, the electronic device 10 may (simultaneously) communicate wirelessly over multiple frequency bands and wireless networks.

The transceiver subsystem 112A may include a transceiver 116A and a transceiver 118A, each of which may be implemented as, or included on, an integrated circuit or system-on-chip. Accordingly, the transceiver subsystem 112A may be included in the processor 12 of the electronic device 10. Additionally, the transceiver 116A and transceiver 118A may be implemented as the transceiver 30 described above. In particular, the transceiver 116A and the transceiver 118A may be utilized for communication associated with one frequency range (e.g., frequencies of or greater than 10 GHz), with the transceiver 116A being utilized to output signals (e.g., to the transceiver 118A or the baseband IC 102) with a frequency in a first portion of the frequency range (e.g., 10 GHz to 13 GHZ), and the transceiver 118A being utilized to output signals (e.g., to the antenna subsystem 114 or to the transceiver 116A) in another portion of the frequency range.

For example, when transmitting, the transceiver 116A may receive a baseband signal from the baseband IC 102 and generate an intermediate frequency RF signal, for instance, utilizing a signal from a phase-lock loop (PLL) 120A that may be mixed (e.g., by a mixer, the modulator 64, or the demodulator 86) with the baseband signal (or a signal resulting from converting the baseband signal from digital to analog). The PLL 120A, as well as each PLL described herein, may include a variable frequency oscillator (VFO), a filter, and a phase detector (e.g., in a feedback loop) that may provide a signal (having a frequency that may be varied based on a frequency of a received RF signal or a frequency of an RF signal to be transmitted) to a mixer, a modulator (e.g., modulator 64), or a demodulator (e.g., demodulator 86) that may be included in a transceiver (e.g., transceiver 108, transceiver 116A, transceiver 118A) of the electronic device 10. The intermediate frequency signal generated by the transceiver 116A may have a frequency between 10 GHz and 13 GHz, inclusive.

The transceiver 118A may receive the intermediate frequency RF signal from the transceiver 116A and generate a RF signal having another frequency from the received intermediate frequency RF signal. For example, in one embodiment, the transceiver 118A may generate an RF signal (e.g., the transmitted signal 70) having a frequency between 24 GHZ and 48 GHZ, inclusive, that may be utilized for mmWave mobile network communication or non-terrestrial network communication. In particular, the transceiver 118A may include a PLL 122 that may be utilized to generate RF signals with frequencies in one frequency range (e.g., between 24 GHZ and 31 GHZ, inclusive) that may be utilized for mmWave mobile network communication or non-terrestrial network communication. The transceiver 118A may also include a PLL 124A that may generate RF signals with frequencies in another frequency range (e.g., between 37 GHz. and 48 GHZ, inclusive) that may be utilized for mmWave mobile network communication.

The transceiver 118A may output generated RF signals to a particular antenna array or antenna included in the antenna subsystem 114, which may transmit the RF signals over a wireless network (e.g., a mmWave mobile network or a non-terrestrial network). The antenna subsystem 114 may include antenna array 126A, antenna array 126B, and antenna array 126C, which may each include one or more of the antennas 55 discussed above as well as filters and/or amplifiers (e.g., power amplifiers or LNAs). Each of the antenna arrays 126 (referring collectively to the antenna array 126A, the antenna array 126B, and the antenna array 126C) may be utilized to send and/or receive RF signals in particular frequency ranges or RF signals in particular wireless networks. For example, the antenna array 126A may be utilized for signals having frequencies of 20 GHz or approximately 20 GHZ. (e.g., 19 GHZ to 21 GHZ, inclusive) and/or non-terrestrial networks. Indeed, in one embodiment, the antenna array 126A may be specifically configured for receiving RF signals from a satellite or another component in a non-terrestrial network. The antenna array 126B may be utilized for transmitting and receiving wireless signals having frequencies in another frequency range, such as 24 GHZ to 31 GHZ that may be utilized for mmWave mobile network communication and non-terrestrial network communication. For non-terrestrial network communication, the antenna array 126B may transmit and/or receive RF signals having frequencies of 30 GHz or approximately 30 GHz (e.g., 29 GHz to 31 GHZ, inclusive). The antenna array 126C may be utilized for transmitting and receiving wireless signals having frequencies in yet another frequency range, such as 37 GHz to 48 GHz that may be utilized for mmWave mobile network communication.

The antenna arrays 126 may receive RF signals (e.g., from a satellite, base station, or other device utilized in a non-terrestrial network or a (mmWave) mobile communication system). The transceiver 118A may demodulate the received RF signals using a PLL such as the PLL 122 or the PLL 124A. The PLL utilized may be determined based on the frequency of the received RF signal or which antenna array 126 received the RF signal. For example, the PLL 122 may be utilized to reduce a frequency of an RF signal received via the antenna array 126B, while the PLL 124A may be utilized to reduce a frequency of an RF signal received by the antenna array 126A or the antenna array 126C. The transceiver 118A may output a signal (e.g., an intermediate frequency RF signal) to the transceiver 116A, which may utilize the PLL 120A to further reduce the frequency of the received signal. The transceiver 116A may subsequently convert the signal from analog to digital and send the resulting digital signal to the baseband IC for processing (e.g., by the baseband IC 102 or the processor 12 (in which the baseband IC 102 may be included)). In this manner, the electronic device 10 may utilize the first wireless communication subsystem 104 to transmit and receive RF signals in one frequency range (in a wireless network) and the second wireless communication subsystem 106 to transmit and receive RF signals in another frequency range (in another wireless network). Indeed, the first wireless communication subsystem 104 may transmit or receive RF signals while the second wireless communication subsystem 106 transmits or receives other RF signals. Somewhat similarly, the second wireless communication subsystem 106 may simultaneously transmit and/or receive RF signals in one frequency range while transmitting or receiving RF signals in another frequency range. For example, the antenna array 126A may receive RF signals (e.g., from a satellite in a non-terrestrial network) while the antenna array 126B or antenna array 126C transmits or receives RF signals (e.g., mm Wave RF signals sent within a mobile communication network or RF signals used in a non-terrestrial network).

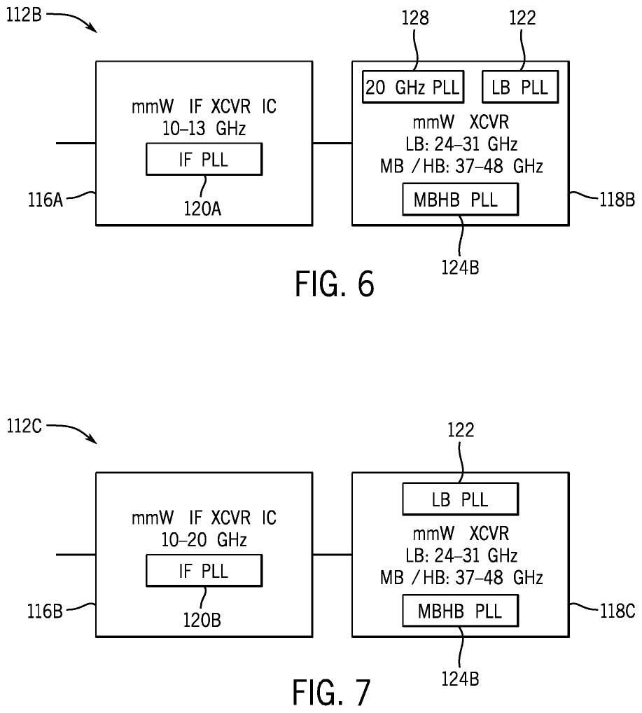

As discussed below with respect to FIG. 6 and FIG. 7, in other embodiments, the transceiver subsystem 112A may be implemented differently. Indeed, FIG. 6 is a block diagram of a transceiver subsystem 112B that includes the transceiver 116A and a transceiver 118B. The transceiver 116A may be the same, and function in same manner, as described above with respect to FIG. 5. The transceiver 118B may include the PLL 122, a PLL 124B, and a PLL 128. The PLL 122 may function as described above. When transmitting, the PLL 124B may generate RF signals with frequencies in another frequency range (e.g., between 37 GHZ and 48 GHZ, inclusive) that may be utilized for mmWave mobile network communication. When receiving, the PLL 124B may be utilized to demodulate RF signals received by the antenna array 126C, meaning the PLL 124B may receive RF signals having a frequency between 24 GHZ and 31 GHZ, inclusive, that may be utilized for mmWave mobile network communication and/or non-terrestrial network communication. The PLL 128 may be utilized for 20 GHz signals to reduce a frequency of RF signals received via the antenna array 126A, such as RF signals that may be received from a satellite (or other device) when communicating in a non-terrestrial network.

FIG. 7 is a block diagram of a transceiver subsystem 112C that includes a transceiver 116B and a transceiver 118C. The transceiver 116B may function similar to the transceiver 116A described above, except that the transceiver 116B may generate RF signals or baseband signals having different frequencies than the transceiver 116A. For example, the transceiver 116B may include a PLL 120B that may generate RF signals (e.g., intermediate frequency RF signals) having a frequency of 10 GHz to 20 GHZ, inclusive. When receiving, the transceiver 116B may generate a baseband signal (e.g., digital baseband signal) from a signal received from the transceiver 118C using the PLL 120. More specifically, the PLL may 120B may reduce a frequency of a received signal, which may include a signal received via the antenna array 126A that may not have been demodulated by the transceiver 118C.

The transceiver 118C may generate RF signals from the intermediate frequency RF signals received from the transceiver 116B and generate RF signals from the intermediate frequency RF signals using the PLL 122 and the PLL 124B, which may operate as described above. For received RF signals, the transceiver 118C may utilize the PLL 122 to demodulate RF signals received via the antenna array 126B, the PLL 124B may be utilized to demodulate RF signals received by the antenna array 126C, meaning the PLL 124B may receive RF signals having a frequency between 24 GHZ and 31 GHZ, inclusive, that may be utilized for mm Wave mobile network communication and/or non-terrestrial network communication. RF signals received via the antenna array 126A may pass through the transceiver 118C and be demodulated by the PLL 120B of the transceiver 116B. In some embodiments, RF signals received via the antenna array 126A may bypass the transceiver 118C and be received directly by the transceiver 116B. As such, embodiments of the second wireless communication subsystem 106 that include the transceiver subsystem 112B or the transceiver subsystem 112C may also simultaneously transmit and/or receive RF signals in one frequency range while transmitting or receiving RF signals in another frequency range. For example, the antenna array 126A may receive RF signals (e.g., from a satellite in a non-terrestrial network) while the antenna array 126B or antenna array 126C transmits or receives RF signals (e.g., mmWave RF signals sent within a mobile communication network or RF signals used in a non-terrestrial network).

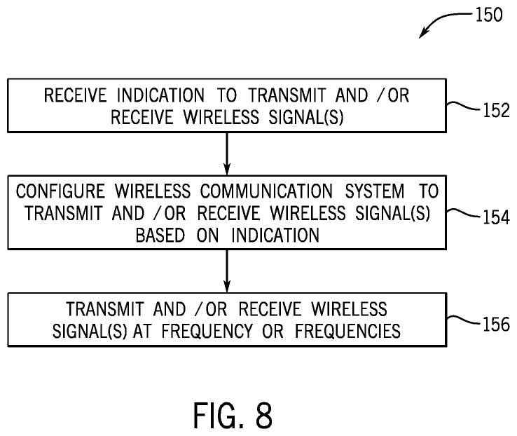

FIG. 8 is a flowchart of a process 150 for the electronic device 10 to transmit and/or receive RF signals on multiple frequency ranges, according to embodiments of the present disclosure. Any suitable device (e.g., a controller) that may control components of the electronic device 10, such as the processor 12, may perform the process 150 utilizing the wireless communication system 100 (e.g., an embodiment of the wireless communication system 100 that includes the transceiver subsystem 112A, the transceiver subsystem 112B, or the transceiver subsystem 112C). In some embodiments, the process 150 may be implemented by executing instructions stored in a tangible, non-transitory, computer-readable medium, such as the memory 14 or storage 16, using the processor 12. For example, the process 150 may be performed at least in part by one or more software components, such as an operating system of the electronic device 10, one or more software applications of the electronic device 10, and the like. While the process 150 is described using steps in a specific sequence, it should be understood that the present disclosure contemplates that the described steps may be performed in different sequences than the sequence illustrated, and certain described steps may be skipped or not performed altogether.

In process block 152, the processor 12 may receive an indication to transmit and/or receive wireless (e.g., RF) signals. Such an indication may be received from the wireless communication system 100, one or more applications executed by the processor 12, or the processor 12 itself. Indeed, in some instances, the processor 12 may generate the indication to transmit and/or receive RF signals and send the indication to the wireless communication system 100 (or one or more components thereof). In some cases, multiple indications may be received at process block 152 (e.g., an indication to transmit or receive on one wireless network and another indication to transmit or receive on another wireless network). For the purposes of facilitating the discussion of the process 150, multiple indications may be referred to herein as being a single indication. Thus, the indication received at process block 152 may be multiple indications.

In process block 154, the wireless communication system 100 may be configured to transmit and/or receive wireless signals based on the indication received in process block 152. More specifically, in process block 154, the processor 12 may cause the wireless communication system 100 (or components thereof) to become configured to operate to transmit or receive wireless signals as indicated by the indication received in process block 152. For example, the processor 12 may cause the baseband IC 102, transceiver 108, the transceiver 116 (referring collectively to the transceiver 116A and the transceiver 116B), the transceiver 118 (referring collectively to the transceiver 118A, the transceiver 118B, and the transceiver 118C), antenna(s) 55B, and/or the antenna arrays 126 to operate in a transmission mode of operation (e.g., to generate signals) or a receiving mode of operation (e.g., to operate on signals received by the antennas 55B or the antenna subsystem 114 or signals generated from the signals received by the antennas 55B or the antenna subsystem 114). It should be noted that a particular transceiver (e.g., the transceiver 108, the transceiver 116, the transceiver 118) may be configured to transmit (e.g., using a transmitter 52) and receive (e.g., using a receiver 54) simultaneously. As such, the wireless communication system 100 may simultaneous transmit RF signals over multiple frequency ranges, receive RF signals over multiple frequency ranges, or transmit over one frequency range while receiving over another frequency range. As a non-limiting example, the second wireless communication subsystem 106 may receive RF signals having frequencies of (or approximately) 20 GHZ (e.g., from a satellite or device of a non-terrestrial network) and transmit RF signals having frequencies of 24 GHz to 48 GHZ (e.g., to a satellite, base station, or other device of a non-terrestrial network or a mmWave mobile communication network).

In process block 156, the wireless communication system 100 may transmit and/or receive wireless signals (e.g., RF signals) at a frequency or frequencies. For example, when transmitting or receiving a single RF signal having a frequency, the wireless communication system 100 may send or receive the RF signal having the frequency. When transmitting multiple RF signals (simultaneously), receiving multiple RF signals (simultaneously) or transmitting and receiving RF signals (simultaneously), such RF signals, as discussed above, may have different frequencies in different frequency ranges (e.g., bands) that may be utilized for different wireless networks or for transmitting or receiving within one wireless network. As such, by performing the process 150, the electronic device 10 may simultaneously transmit, receive, or transmit and receive RF signals over multiple frequency ranges and/or wireless networks including, but not limited to, non-terrestrial networks and (mmWave) mobile communication networks.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A wireless communication system comprising:
a first transceiver configured to transmit and receive one or more first wireless signals over a cellular network using a first frequency range;
at least one antenna communicatively coupled to the first transceiver to transmit and receive the one or more first wireless signals;
a second transceiver configured to transmit and receive one or more second wireless signals over a non-terrestrial network using a second frequency range different than the first frequency range; and
a plurality of antennas communicatively coupled to the second transceiver, wherein the plurality of antennas comprises
one or more first antennas to transmit and receive a first portion of the one or more second wireless signals in a first portion of the second frequency range, and
one or more second antennas to transmit and receive a second portion of the one or more second wireless signals in a second portion of the second frequency range.

2. The wireless communication system of claim 1, wherein the one or more first antennas are configured to receive the first portion of the one or more second wireless signals while the second transceiver or the one or more second antennas transmit the second portion of the one or more second wireless signals.

3. The wireless communication system of claim 1, wherein
the first portion of the second frequency range comprises a first frequency of 20 gigahertz (GHz), and
the second portion of the second frequency range comprises a second frequency of 30 GHz.

4. The wireless communication system of claim 1, wherein
a maximum frequency of the first frequency range is less than or equal to 8 gigahertz (GHz), and
a minimum frequency of the second frequency range is greater than or equal to 20 GHz.

5. The wireless communication system of claim 1, comprising a third transceiver communicatively coupled to the second transceiver and configured to modify one or more baseband signals to generate one or more intermediate signals in a third frequency range.

6. The wireless communication system of claim 5, wherein the third frequency range comprises a maximum frequency that is less than a minimum frequency of the second frequency range.

7. The wireless communication system of claim 5, wherein
the second transceiver is configured to receive the one or more intermediate signals, and
the second transceiver comprises one or more first phase-locked loops (PLLs) configured to generate the one or more second wireless signals based on the one or more intermediate signals.

8. The wireless communication system of claim 7, wherein the second transceiver comprises a PLL configured to
receive the first portion of the one or more second wireless signals received via the one or more first antennas, and
generate one or more signals based on the first portion of the one or more second wireless signals.

9. The wireless communication system of claim 7, wherein the third transceiver comprises a second PLL configured to
receive the first portion of the one or more second wireless signals received via the one or more first antennas, and
reduce a second frequency of the first portion of the one or more second wireless signals.

10. A method, comprising:
transmitting or receiving, via a first transceiver and at least one antenna communicatively coupled to the first transceiver, one or more first wireless signals over one or more cellular networks using a first frequency range;
transmitting or receiving, via a second transceiver and one or more first antennas of a plurality of antennas communicatively coupled to the second transceiver, a first portion of one or more second wireless signals over one or more non-terrestrial networks using a first portion of a second frequency range; and
transmitting or receiving, via the second transceiver and one or more second antennas of the plurality of antennas, a second portion of the one or more second wireless signals over the one or more cellular networks or the one or more non-terrestrial networks using a second portion of the second frequency range.

11. The method of claim 10, comprising transmitting, via the second transceiver and one or more third antennas, a third portion of the one or more second wireless signals using the one or more cellular networks using a third portion of the second frequency range.

12. The method of claim 10, wherein the first frequency range comprises L band frequencies and S band frequencies as designated by the Institute of Electrical and Electronics Engineers.

13. The method of claim 10, wherein the second frequency range comprises a first frequency of 20 gigahertz (GHz) and a second frequency of 30 GHz.

14. The method of claim 13, wherein
the first portion of the second frequency range comprises the first frequency, and
the second portion of the second frequency range comprises the second frequency.

15. The method of claim 10, comprising
transmitting, via the first transceiver or one or more third antennas communicatively coupled to the first transceiver, the one or more first wireless signals while the second transceiver or the plurality of antennas receives the one or more second wireless signals, or
receiving, via the first transceiver or the one or more third antennas, the one or more first wireless signals while the second transceiver or the plurality of antennas transmits the one or more second wireless signals.

16. The method of claim 10, comprising:
receiving, via a third transceiver communicatively coupled to the second transceiver, one or more baseband signals;
generating, via the third transceiver, one or more intermediate signals based on the one or more baseband signals; and
generating, via the second transceiver, the one or more second wireless signals based on the one or more intermediate signals.

17. An electronic device comprising:
a first transceiver configured to transmit and receive one or more first wireless signals over a cellular network using a first frequency range;
a second transceiver configured to transmit and receive one or more second wireless signals over a non-terrestrial network using a second frequency range; and
a plurality of antennas communicatively coupled to the second transceiver, wherein the plurality of antennas comprises
one or more first antennas configured to receive a first portion of the one or more second wireless signals, and
one or more second antennas configured to transmit a second portion of the one or more second wireless signals.

18. The electronic device of claim 17, wherein the one or more first antennas are configured to receive the first portion of the one or more second wireless signals while the one or more second antennas transmit the second portion of the one or more second wireless signals.

19. The electronic device of claim 17, wherein
the first portion of the one or more second wireless signals have a first frequency within 19 gigahertz (GHz) and 21 GHz, and
the second portion of the one or more second wireless signals have a second frequency within 24 GHz and 31 GHz.

20. The electronic device of claim 17, wherein
the first portion of the one or more second wireless signals are communicated via the non-terrestrial network, and
the second portion of the one or more second wireless signals are communicated via the non-terrestrial network.
